(19) United States
(12) Patent Application Publication
(10) Pub. No.: US 2010/0229469 A1
(43) Pub. Date: Sep. 16, 2010

(54) OPENING/CLOSING UNIT AND OPENING/CLOSING UNIT FOR VEHICLE WINDOWS

(75) Inventor: Makoto Kanehira, Osaka (JP)

Correspondence Address: Leason Ellis LLP, 81 Main Street, Suite 503, White Plains, NY, 10601, US

(73) Assignee: TSUBAKIMOTO CHAIN CO., Osaka (JP)

(21) Appl. No.: 12/716,920

(22) Filed: Mar. 3, 2010

(30) Foreign Application Priority Data
Mar. 13, 2009 (JP) 2009-060892

(51) Int. Cl. E05F 11/48; E05F 11/04; E05F 11/06

(52) U.S. Cl. 49/358

(57) ABSTRACT

In a structure including rotary gears spaced apart from each other in a radial direction, and chains which are placed to face each other, engage individually with the respective rotary gears and move in an interlocking manner, have flexible chain sections and flexure preventing sections which project from the chain sections and come into engagement with each other at a point located on one end side with respect to an engaged portion where the chains engage with the rotary gears, and are attached at their one ends to a sliding body such as a window glass, the flexure preventing sections are brought into engagement with each other to prevent the chains from flexing in separating directions and join them together to make one end side of the chains a non-flexible portion in the form of an angular bar.

### CROSS-REFERENCE TO RELATED APPLICATION

This non-provisional application claims priority under 35 U.S.C. §119(a) on Patent Application No. 2009-060892 filed in Japan on Mar. 13, 2009, the entire contents of which are hereby incorporated by reference.

### BACKGROUND

1. Technical Field

The present invention relates to an opening/closing unit for opening/closing an open section with a sliding body which is mounted slidably in the open section, and an opening/closing unit for opening/closing a vehicle window with a window glass which is mounted slidably in the vehicle-window.

2. Description of Related Art

A window glass and an opening/closing unit for opening/closing a window by sliding the window glass is built into doors for automobiles (see, for example, Japanese Patent Application Laid-Open No. H05-202673 (1993) and Japanese Utility Model Application Laid-Open No. S63-104583 (1988)). The opening/closing unit disclosed in Japanese Patent Application Laid-Open No. H05-202673 (1993) includes guide rails which are located on the upper and lower sides and have cable guides at both upper and lower edges; a sliding body supported slidably on the guide rails and attached to the lower edge of the window glass; two cables fastened to the cable guides and having one ends connected to the sliding body; and an electric motor having a drum for winding each of the cables. The opening/closing unit disclosed in Japanese Patent Application Laid-Open No. H05-202673 (1993) is designed to slide the window glass in a closing direction by winding one of the cables around the drum and to slide the window glass in an opening direction by winding the other cable around the drum.

The opening/closing unit disclosed in Japanese Utility Model Application Laid-Open No. S63-104583 (1988) includes two arms with one ends fastened to the lower edge of the window glass and pivotably supported at the center in the longitudinal direction; a fixed plate for supporting pivotably the other end of one of the arms; a gear plate supported pivotably on the fixed plate; an electric motor for swinging the gear plate; a link for transmitting the movement of the gear plate to the one arm; and a guide bracket for supporting slidably the other end of the other arm. The opening/closing unit disclosed in Japanese Utility Model Application Laid-Open No. S63-104583 (1988) is designed to slide the window glass in the closing direction by the movement of the gear plate in one direction and to slide the window glass in the opening direction by the movement of the gear plate in the other direction.

### SUMMARY

However, since the opening/closing unit for vehicle windows disclosed in Japanese Patent Application Laid-Open No. H05-202673 (1993) requires a large number of parts, such as guide rails, a sliding body and two cables, the structure is complicated and the costs are high. Moreover, since it requires a layout in which the guide rails are located on the sides of the closed window glass, the degree of freedom in layout is small, and there is also a problem that when one of the cables is disconnected, the window glass opens by its own weight.

In the opening/closing unit for vehicle windows disclosed in Japanese Utility Model Application Laid-Open No. S63-104583 (1988), since a large number of parts such as two arms, a fixed plate and a gear plate are required, the structure is complicated and the costs are high. Moreover, since it requires a layout in which the two arms are located under the window glass slid in the closing direction, there is a problem that the degree of freedom in layout is small.

The present invention has been made with the aim of solving the above problems, and it is a major object of the present invention to provide an opening/closing unit capable of opening/closing an open section with a small number of parts and increasing the degree of freedom in layout by including at least one rotary gear, and two chains which are placed to face each other, engage with the rotary gear and move in an interlocking manner, have flexible chain sections and flexure preventing sections which project from the chain sections and prevent flexing of the chain sections by coming into engagement with each other at a point located on one end side with respect to an engaged portion where the chain engages with the rotary gear, each of the chains having one end attached to a sliding body such as a window glass.

Another object is to provide an opening/closing unit including a guide body which comes into contact with the chain sections on the other end side with respect to the engaged portion and guides at least one of the two chains in a direction in which the chain section is flexed, and thereby capable of bringing the respective chains into a flexible state and separating and moving them in two directions when sliding a sliding body such as a window glass in an opening direction.

Other object is to provide an opening/closing unit including storage sections for storing the other end side of the two chains with respect to the engaged portion, and thereby capable of compactly storing the flexible other end side of the chains in the storage sections and capable of being placed in a relatively narrow space.

Other object is to provide an opening/closing unit capable of smoothly storing and pulling out the chains without twisting them by providing the storage sections with two guide sections for guiding the chain section, the guide sections being placed facing each other with a space therebetween in a direction in which the chain section is flexible.

Other object is to provide an opening/closing unit capable of sliding a curved sliding body in a direction along the curve of the sliding body by providing each of the chains with means for allowing the chain to curve on one end side where flexing is prevented by the flexure preventing sections.

Other object is to provide an opening/closing unit including two chains which are placed to face each other between a plurality of rotary gears disposed apart from each other in a radial direction, and guide body with two guide sections for guiding the chains to sides in a direction in which the rotary gears are separated from each other, and capable of arranging the rotary gears, chains and storage sections in series in a direction crossing the sliding direction of a sliding body such as a window glass by locating the storage sections on the sides in the direction in which the rotary gears are separated from each other.

Other object is to provide an opening/closing unit including a plurality of rotary gears disposed apart from each other in a longitudinal direction of a non-flexible portion of one end side of each of the chains which is prevented from flexing by the flexure preventing sections, and a guide body having two guide sections for guiding the respective chains to the same side in a direction crossing the longitudinal direction, and capable of being placed compactly even when the space on the same side in a direction crossing the sliding direction of a sliding body such as a window glass is relatively narrow by locating the storage sections apart from each other in the longitudinal direction.

Other object is to provide an opening/closing unit including a plurality of rotary gears disposed apart from each other in a longitudinal direction of a non-flexible portion of one end side of each of the chains which is prevented from flexing by the flexure preventing sections, a guide body having a guide section for guiding one of the two chains to a side in a direction crossing the longitudinal direction and a guide section for guiding the other of the two chains in the longitudinal direction, and capable of being placed compactly even when the space on a side in a direction crossing the sliding direction of a sliding body such as a window glass is relatively narrow by locating the storage sections on the side in the direction crossing the longitudinal direction and on a side in the longitudinal direction.

Other object is to provide an opening/closing unit for vehicle windows capable of opening/closing a vehicle window with a small number of parts and increasing the degree of freedom in layout by including a rotary gear, and two chains which are placed to face each other, engage with the rotary gear and move in an interlocking manner, have flexible chain sections and flexure preventing sections which project from the chain sections and prevent flexing of the chain sections by coming into engagement with each other at a point located on one end side with respect an engaged portion where the chain engages with the rotary gear, each of the chains having one end attached to the window glass.

Other object is to provide an opening/closing unit for vehicle windows capable of opening/closing a vehicle window with a small number of parts and increasing the degree of freedom in layout by including a rotary gear; two chains which are placed to face each other, engage with the rotary gear and move in an interlocking manner, have flexible chain sections and flexure preventing sections which project from the chain sections and prevent flexing of the chain sections by coming into engagement with each other at a point located on one end side with respect to an engaged portion where the chain engages with the rotary gear, each of the chains having one end attached to the window glass; a guide body for coming into contact with the chain sections on the other end side with respect to the engaged portion and guiding each of the chains in a lateral direction; and storage sections for storing the other end side of each of the chains.

An opening/closing unit according to the present invention is an opening/closing unit for opening/closing an open section with a sliding body which is mounted slidably in the open section, and characterized by comprising: at least one rotary gear; and two chains which are placed to face each other, engage with the rotary gear and move in an interlocking manner, include flexible chain sections and flexure preventing sections which project from the chain sections and prevent flexing of the chain sections by coming into engagement with each other at a point located on one end side with respect to an engaged portion where the chain engages with the rotary gear, each of the chains having one end attached to the sliding body.

In the present invention, since the open section is opened and closed with a simple structure comprising a rotary gear and chains, the opening/closing unit is provided at relatively low cost. Moreover, since the other end side of each chain is freely flexed, the degree of freedom in layout is increased. Furthermore, since the chains which are prevented from flexing slide the sliding body, high rigidity and improved durability are achieved.

The opening/closing unit according to the present invention is characterized by comprising a guide body for coming into contact with the chain sections on the other end side with respect to the engaged portion and guiding at least one of the two chains in a direction in which the chain section is flexed.

In the present invention, when sliding the sliding body in an opening direction, the chains are brought into a flexible state and separated and moved in two directions, and therefore the degree of freedom in layout is further increased.

The opening/closing unit according to the present invention is characterized by comprising storage sections for storing the other end side of each of the chains with respect to the engaged portion.

In the present invention, since the flexible other end side of the chain is stored compactly in the storage section, even when the sliding distance of the sliding body is relatively long, it is possible to place the opening/closing unit in a relatively narrow space.

The opening/closing unit according to the present invention is characterized in that the storage section includes two guide sections for guiding the chain section, the guide sections being placed facing each other with a space therebetween in a direction in which the chain section is flexible.

In the present invention, the chain section of the chain is placed between the two guide sections in the storage section and the chain is moved along the guide sections, and therefore the chain is smoothly stored and pulled out without being twisted.

The opening/closing unit according to the present invention is characterized in that each of the chains includes means for allowing the chain to curve on one end side where flexing is prevented by the flexure preventing sections.

In the present invention, since the one end side which is prevented from flexing by the flexure preventing sections is allowed to curve, it is possible to slide a curved sliding body in a direction along the curve of the sliding body.

The opening/closing unit according to the present invention is characterized in that a plurality of the rotary gears are disposed apart from each other in a radial direction, the chains are placed to face each other between the rotary gears, the guide body includes two guide sections for guiding the chains to sides in a direction in which the rotary gears are separated from each other, and the storage sections are located on the sides in the direction in which the rotary gears are separated from each other.

In the present invention, since the rotary gears, chains and storage sections are arranged in series in a direction crossing the sliding direction of the sliding body, it is possible to dispose the opening/closing unit parallel to the sliding body one above the other.

The opening/closing unit according to the present invention is characterized in that a plurality of the rotary gears are disposed apart from each other in a longitudinal direction of a non-flexible portion of the one end side of each of the chains which is prevented from flexing by the flexure preventing sections, the guide body includes two guide sections for guiding the chains to the same side in a direction crossing the longitudinal direction, and the storage sections are located apart from each other in the longitudinal direction.

In the present invention, since the rotary gears and the storage sections are located on the same side in a direction crossing the sliding direction of the sliding body to face each other in the sliding direction, the opening/closing unit may be placed compactly even when the space on the same side in a direction crossing the sliding direction of the sliding body is relatively narrow.

The opening/closing unit according to the present invention is characterized in that a plurality of rotary gears are disposed apart from each other in a longitudinal direction of a non-flexible portion of the one end side of each of the chains which is prevented from flexing by the flexure preventing sections, the guide body includes a guide section for guiding one of the two chains to a side in a direction crossing the longitudinal direction, and a guide section for guiding the other of the two chains in the longitudinal direction, and the storage sections are located on the side in the direction crossing the longitudinal direction and on a side in the longitudinal direction.

In the present invention, since the storage sections are separately disposed on one side in a direction crossing the sliding direction of the sliding body and in the sliding direction, even when the space on the side in the direction crossing the sliding direction of the sliding body is relatively narrow, the opening/closing unit is placed compactly.

The opening/closing unit for vehicle windows according to the present invention is an opening/closing unit for opening/closing a vehicle window with a window glass which is mounted slidably in the vehicle window, and characterized by comprising: at least one rotary gear; and two chains which are placed to face each other, engage with the rotary gear and move in an interlocking manner, include flexible chain sections and flexure preventing sections which project from the chain sections and prevent flexing of the chain sections by coming into engagement with each other at a point located on one end side with respect to an engaged portion where the chain engages with the rotary gear, each of the chains having one end attached to the window glass.

In the present invention, since the window glass is slid by the rotary gear and chains, the opening/closing unit is provided at low cost. Moreover, since the other end side of each chain is freely flexed, the degree of freedom in layout is increased. Further, since the chains which are prevented from flexing slide the sliding body, high rigidity and improved durability are achieved.

An opening/closing unit for vehicle windows according to the present invention is an opening/closing unit for opening/closing a vehicle window with a window glass which is mounted vertically slidably in the vehicle window, and characterized by comprising: at least one rotary gear; two chains which are placed to face each other, engage with the rotary gear and move in an interlocking manner, and include flexible chain sections and flexure preventing sections which project from the chain sections and prevent flexing of the chain sections by coming into engagement with each other at a point located on one end side with respect to an engaged portion where the chain engages with the rotary gear, each of the chains having one end attached to a lower edge of the window glass; a guide body for coming into contact with the chain sections on the other end side with respect to the engaged portion and guiding each of the chains in a lateral direction; and storage sections for storing the other end side of each of the chains.

In the present invention, since the window glass is slid vertically by the rotary gear and chains, the opening/closing unit is provided at low cost. Moreover, since the other end side of each chain is freely flexed, the degree of freedom in layout is increased. Further, since the chains which are prevented from flexing slide the sliding body, high rigidity and improved durability are achieved.

According to the present invention, the opening/closing unit is provided at low cost because the open section is opened and closed with a relatively small number of parts, and also the degree of freedom in layout is increased because the other end side of each chain is freely flexed.

According to the present invention, when sliding the sliding body in an opening direction, the chains are brought into a flexible state and moved separately in two directions, and therefore the degree of freedom in layout is further increased.

According to the present invention; since the flexible other end side of the chains is compactly stored in the storage sections, it is possible to place the opening/closing unit in a relatively narrow space.

According to the present invention, since the chain section of each chain may be placed between the two guide sections of the storage section to move the chain along the guide sections, the chains are smoothly stored and pulled out without being twisted.

According to the present invention, since one end side which is prevented from flexing by the flexure preventing sections is allowed to curve, it is possible to slide a curved sliding body in a direction along the curve of the sliding body.

According to the present invention, since the rotary gear, chains and storage sections may be arranged in series in a direction crossing the sliding direction of the sliding body, it is possible to dispose the opening/closing unit parallel to the sliding body one above the other.

According to the present invention, since the rotary gears and the storage sections may be located on the same side in a direction crossing the sliding direction of the sliding body to face each other in the sliding direction, even when the space on the same side in the direction crossing the sliding direction of the sliding body is relatively narrow, the opening/closing unit is placed compactly.

According to the present invention, since the storage sections may be disposed separately on one side in a direction crossing the sliding direction of the sliding body and in the sliding direction of the sliding body, even when the space on the side in the direction crossing the sliding direction of the sliding body is relatively narrow, the opening/closing unit is placed compactly.

According to the present invention, the opening/closing unit is provided at low cost because the vehicle window is opened and closed by the rotary gear and chains, and also the degree of freedom in layout is increased because the other end side of each chain is freely flexed.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic front view illustrating a structure of an opening/closing unit according to the present invention;

FIG. 2 is an enlarged front view of essential sections of the opening/closing unit according to the present invention;

FIG. 3 is an enlarged plan view of essential sections of the opening/closing unit according to the present invention;

FIG. 4 is a perspective view illustrating a structure of chains in the opening/closing unit according to the present invention;

FIG. 5 is an enlarged cross sectional view illustrating a structure of chains in the opening/closing unit according to the present invention;

FIG. 6 is a front view illustrating a structure of a guide body and a storage section in the opening/closing unit according to the present invention;

FIG. 7 is a cross sectional view illustrating the relation between the chain and the guide body in the opening/closing unit according to the present invention;

FIG. 8 is a schematic explanatory view illustrating a state in which the opening/closing unit according to the present invention is mounted to a vehicle door;

FIG. 9 is a schematic front view illustrating other structure of the opening/closing unit according to the present invention;

FIG. 10 is a schematic explanatory view illustrating other structure of the opening/closing unit according to the present invention;

FIG. 11 is a schematic explanatory view illustrating other structure of the opening/closing unit according to the present invention;

FIG. 12 is a schematic explanatory view illustrating other structure of the opening/closing unit according to the present invention;

FIG. 13 is a schematic front view illustrating other structure of the opening/closing unit according to the present invention.

FIG. 14 is an explanatory view illustrating the relation between a rotary gear and the guide body in the opening/closing unit according to the present invention;

FIG. 15 is an enlarged cross sectional view of a chain in the other structure of the opening/closing unit according to the present invention;

FIG. 16 is a schematic plan view illustrating other structure of the opening/closing unit according to the present invention;

FIG. 17 is a partly enlarged front view of the chain in the opening/closing unit according to the present invention; and

FIG. 18 is an enlarged side view of the chain in the other structure of the opening/closing unit according to the present invention.

### DETAILED DESCRIPTION

The following description will explain the present invention in detail on the basis of the drawings illustrating some embodiments thereof.

### Embodiment 1

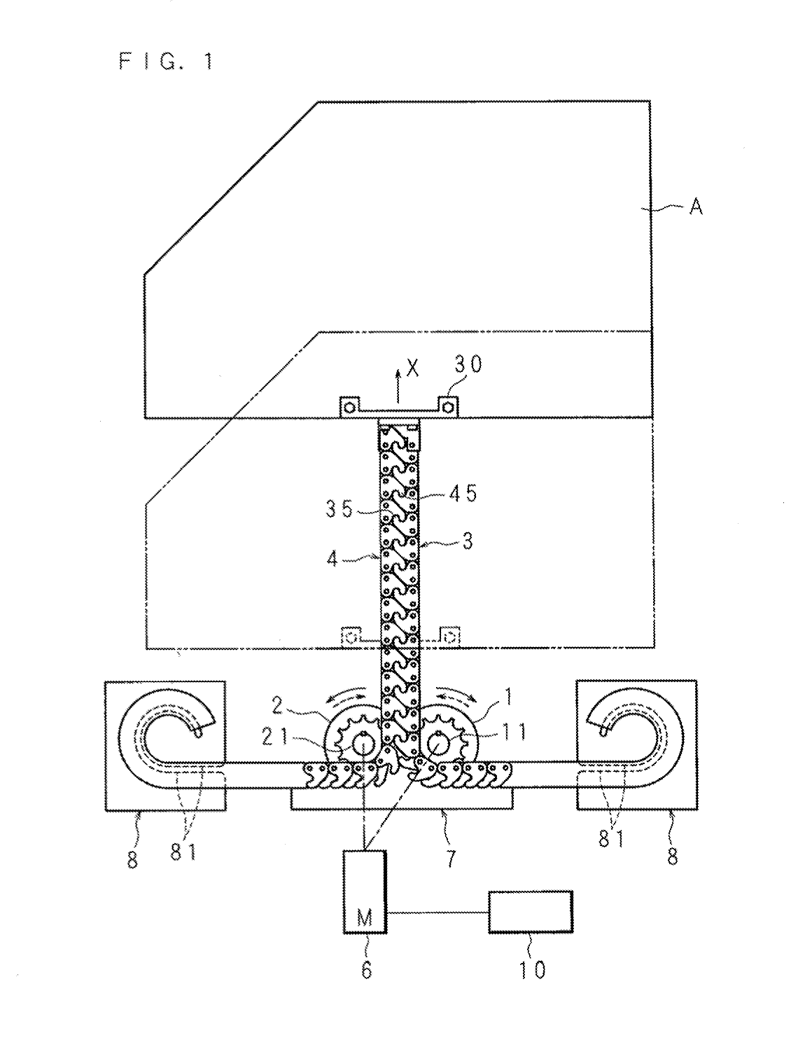

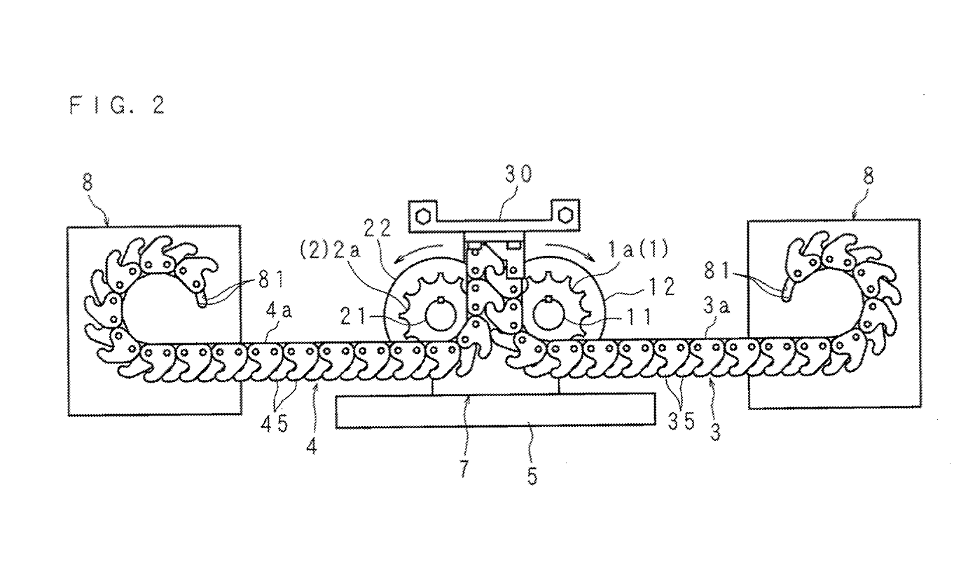

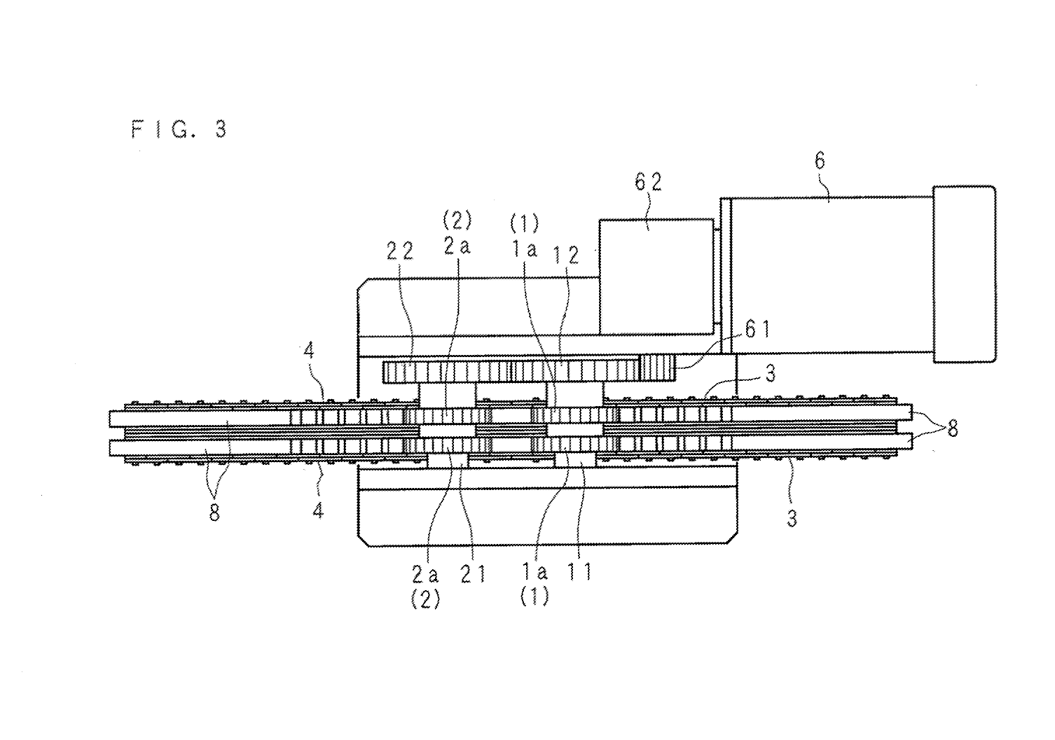

FIG. 1 is a schematic front view illustrating a structure of an opening/closing unit according to the present invention, FIG. 2 is an enlarged front view of essential sections of the opening/closing unit, and FIG. 3 is an enlarged plan view of essential sections of the opening/closing unit.

The opening/closing unit illustrated in the drawings is a unit for sliding a sliding body A, which is mounted slidably in a vehicle window (open section), in a closing direction and an opening direction. The opening/closing unit comprises two rotary gears 1 and 2 spaced apart from each other in a radial direction with their axial centers parallel to each other; two chains 3 and 4 which are placed to face each other between the rotary gears 1 and 2, engage individually with the rotary gears 1 and 2 and move in an interlocking manner; a supporting body 5 for supporting the rotary gears 1 and 2 rotatably; an electric motor 6 for rotating the rotary gears 1 and 2 synchronously; a guide body 7 for guiding the chains 3 and 4 in directions in which the rotary gears 1 and 2 are separated from each other; and two storage sections 8, 8 for storing the ends of the chains 3 and 4 guided by the guide body 7.

As illustrated in FIG. 2 and FIG. 3, the rotary gear 1 includes two sprockets 1a and 1a having a plurality of teeth on their outer circumference and arranged coaxially on the outer circumference of a rotation shaft 11. As illustrated in FIG. 2 and FIG. 3, the rotary gear 2 includes two sprockets 2a and 2a having a plurality of teeth on their outer circumference and arranged coaxially on the outer circumference of a rotation shaft 21. Both ends of the rotation shafts 11 and 21 are supported rotatably on the supporting body 5 with bearings. The rotary gears 1 and 2 are separated from each other in a radial direction by such a distance between the shaft centers that allows the opposing surfaces of the chains 3 and 4 to come into contact with each other when the chains 3 and 4 placed facing each other engage.

Provided on the outer circumference of one end side of each of the rotation shafts 11 and 21 are transmission gears 12 and 22 which engage with each other. A reduction gear 62 having a drive gear 61 which engages with one transmission gear 12, and the electric motor 6 for driving the reduction gear 62 are supported on the supporting body 5. In such a structure, with a rotation of the drive gear 61, the rotary gears 1 and 2 rotate in opposite directions in synchronous with each other and move the chains 3 and 4 in an interlocking manner.

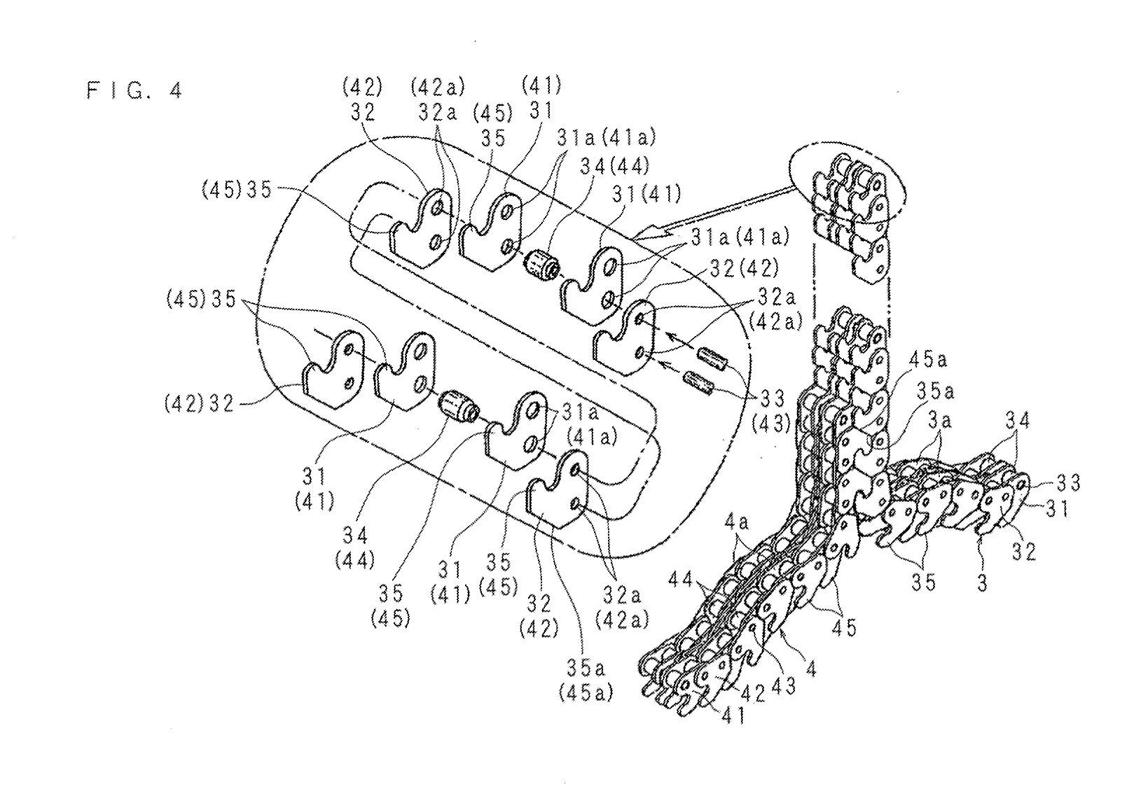

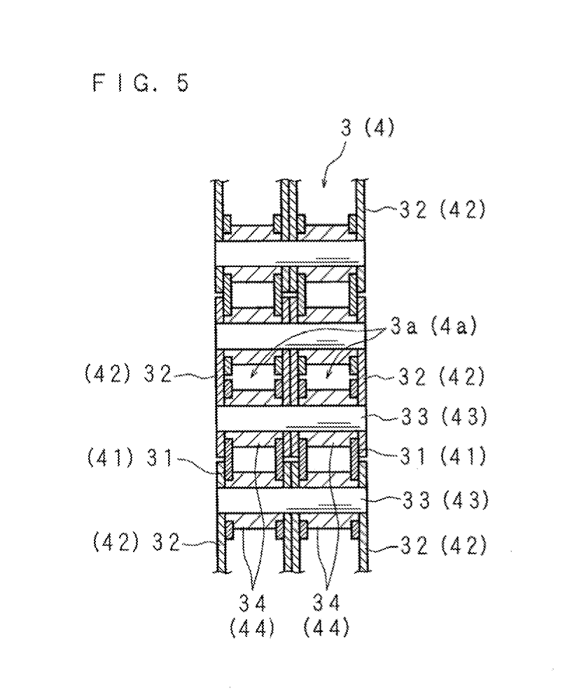

FIG. 4 is a perspective view illustrating a structure of the chains, and FIG. 5 is an enlarged cross sectional view illustrating the structure of the chains. The chains 3 and 4 are double-strand roller chains including two chain sections 3a and 4a which engage with two sprockets 1a, 1a and 2a, 2a of the respective rotary gears 1 and 2, and the chains 3 and 4 have an attachment part 30 to be attached to the sliding body A at their one end.

The chain 3 includes substantially oval-shaped four roller link plates 31, 31 . . . which are arranged to face each other with a space therebetween, and four pin link plates 32, 32 . . . which are placed to face each other and partly overlap the roller link plates 31, 31 . . . and have later-described flexure preventing sections. Moreover, the chain 3 includes a pin 33 for connecting the overlapped part of each of the roller link plates 31, 31 . . . and pin link plates 32, 32 . . . so that they are turnable relative to each other. Thus, two chain sections 3a and 3a in the form of flexible chains are formed. Furthermore, a roller 34 is placed between two opposing roller link plates 31 and 31, and supported rotatably with the pin 33. Both ends of the roller 34 are provided with small-diameter cylindrical parts.

Formed on both ends of each of the roller link plates 31, 31 . . . are fitting holes 31a and 31a into which the small-diameter cylindrical parts on both ends of the rollers 34 are fitted so that they are turnable relative to each other. Formed on both ends of the pin link plates 32, 32 . . . are fitting holes 32a and 32a into which the both ends of the pin 33 are fitted and fixed. Thus, by connecting the roller link plates 31, 31 . . . and the pin link plates 32, 32 . . . so that they are freely flexed about the pins 33, the two chain sections 3a and 3a are formed.

Hook-like flexure preventing sections 35, 35 . . . which project outward from one side in a width direction on the other end side and are curved to one end side are formed integrally with the respective roller link plates 31, 31 . . . and pin link plates 32, 32 . . . . The side edge in the middle of each of the flexure preventing sections 35, 35 . . . has a flat contact part 35a.

The chain 4 includes substantially oval-shaped four roller link plates 41, 41 . . . which are arranged to face each other with a space therebetween, and four pin link plates 42, 42 . . . which are placed to face each other and partly overlap the roller link plates 41, 41 . . . and have later-described flexure preventing sections. Moreover, the chain 4 includes a pin 43 for connecting the overlapped part of each of the roller link plates 41, 41 . . . and pin link plates 42, 42 . . . so that they are turnable relative to each other. Thus, two chain sections 4a and 4a in the form of flexible chains are formed. Furthermore, a roller 44 is placed between two opposing roller link plates 41 and 41 and supported rotatably with the pin 43. Both ends of the roller 44 are provided with small-diameter cylindrical parts.

Formed on both ends of each of the roller link plates 41, 41 . . . are fitting holes 41a and 41a into which the small-diameter cylindrical parts on both ends of the roller 44 are fitted so that they are turnable relative to each other. Formed on both ends of each of the pin link plates 42, 42 . . . are fitting holes 42a and 42a into which the both ends of the pin 43 are fitted and fixed. Thus, by connecting the roller link plates 41, 41 . . . and the pin link plates 42, 42 . . . so that they are freely flexed about each pin 43, two chain sections 4a and 4a are formed.

Hook-like flexure preventing parts 45, 45 . . . which project outward from one side in a width direction on one end side and are curved to the other end side are formed integrally with the respective roller link plates 41, 41 . . . and pin link plates 42, 42 . . . . The side edge in the middle of each of the flexure preventing sections 45, 45 . . . has a flat contact section 45a.

The chains 3 and 4 are placed to face each other between the rotary gears 1 and 2 so that the chain 3 engages with the rotary gear 1 in a state in which the flexure preventing sections 35, 35 . . . face one end and the chain 4 engages with the rotary gear 2 in a state in which the flexure preventing sections 45, 45 . . . face the other end. When the rotary gears 1 and 2 rotate in the directions indicated with the solid-line arrows in FIG. 2 and the chains 3 and 4 move in an interlocking manner in one direction (the direction indicated with arrow X in FIG. 1), the flexure preventing sections 35, 35 . . . and 45, 45 . . . of the chains 3 and 4 come into engagement with each other on one end side with respect to an engaged portion where they engage with the respective rotary gears 1 and 2 as illustrated in FIG. 2. At this time, the opposing chains 3 and 4 are prevented from flexing in separating directions and joined together, and the one end side of the chains 3 and 4 becomes a non-flexible portion in the form of an angular bar.

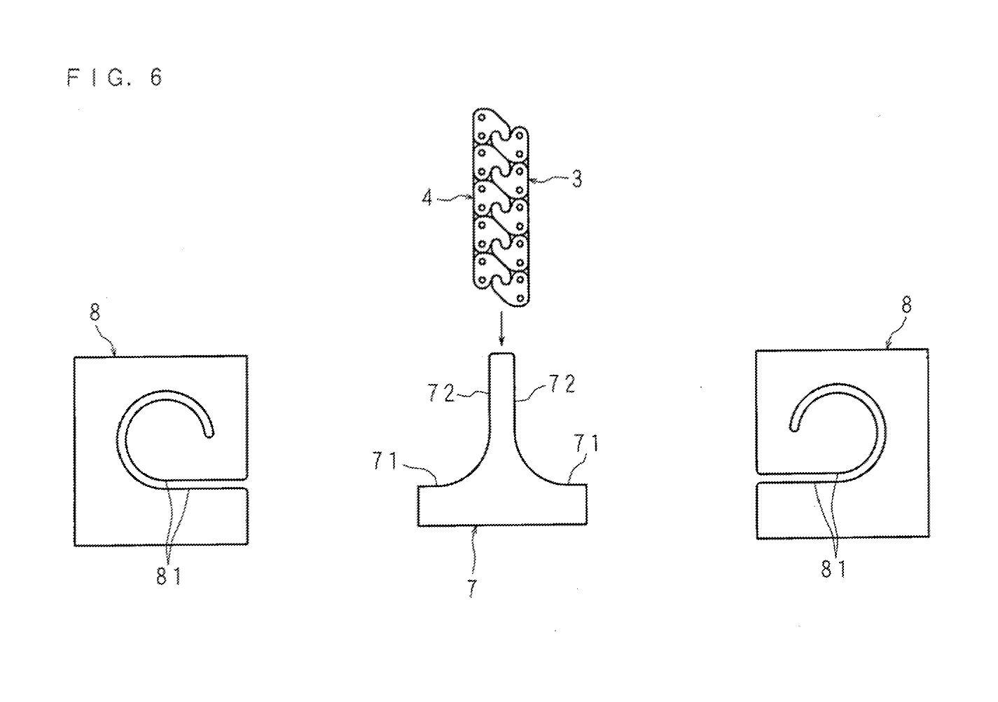

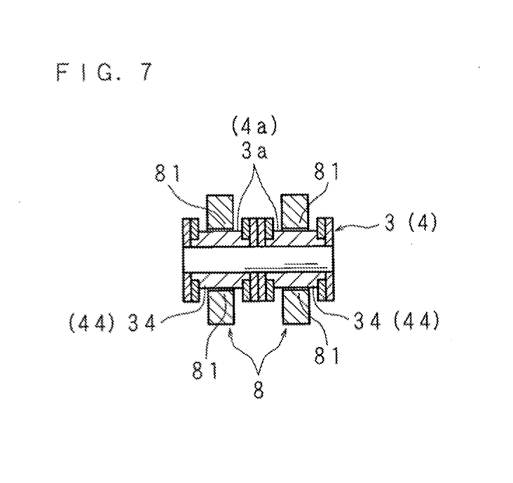

FIG. 6 is a front view illustrating the structure of the guide body and the storage sections, and FIG. 7 is a cross sectional view illustrating the relation between the chains and the guide body. The guide bodies 7 are provided for the double-strand roller chains and disposed to face each other with a space between them in the axial direction of the rotation shafts 11 and 21. However, since they have the same configuration, only the guide body 7 located on one side will be explained below.

The guide body 7 is configured in the form of a plate which comes into contact with the circumferential face of each of the rollers 34, 44 of the chains 3 and 4. As illustrated in FIG. 2, in the vicinity of the rotary gears 1 and 2, the guide body 7 has a substantially inverted T shape with two first guide sections 71 and 71 which are located in a direction in which the rotary gears 1 and 2 are separated from each other, and two second guide sections 72 and 72 which are curved from the opposite sides of the first guide sections 71 and 71 toward the center between the sprockets 1a and 2a of the rotary gears 1 and 2. When the rotary gears 1 and 2 rotate in the directions indicated with the solid-line arrows in FIG. 1, the first guide sections 71, 71 guide the chains 3 and 4 in a direction so that the chain sections 3a and 4a of the chains 3 and 4 face each other. When the rotary gears 1 and 2 rotate in the directions indicated with the broken-line arrows in FIG. 1, the second guide sections 72, 72 guide the chains 3 and 4 in directions to separate the chain sections 3a and 4a of the chains 3 and 4 from each other. The guide body 7 is mounted on the supporting body 5.

The storage sections 8, 8 are provided for the double-strand roller chains and disposed to face each other with a space therebetween in the axial direction of the rotation shafts 11 and 21. However, since the storage sections 8, 8 have the same configuration, only the storage sections 8, 8 located on one side will be explained below.

The storage sections 8, 8 are formed of plate bodies including two guide parts 81, 81 that come into contact with the circumferential face of each roller 34, 44 of the chains 3 and 4. The guide parts 81, 81 have a substantially J shape, face each other and are separated from each other by a distance greater than the outer diameter of the roller 34, 44 in a direction in which each chain 3, 4 is flexible. The other ends of the chains 3 and 4 are inserted into the starting ends of the storage sections 8, 8. The separation distance between the guide parts 81, 81 is shorter than the width of each of the roller link plates 31, 31, . . . , 41, 41 . . . so that the inner faces of the roller link plates 31, 31, . . . , 41, 41 . . . come into contact with the guide parts 81, 81 to prevent displacement of the chains 3 and 4. The two storage sections 8, 8 are disposed apart from each other with their starting ends facing each other, and mounted on the supporting body 5.

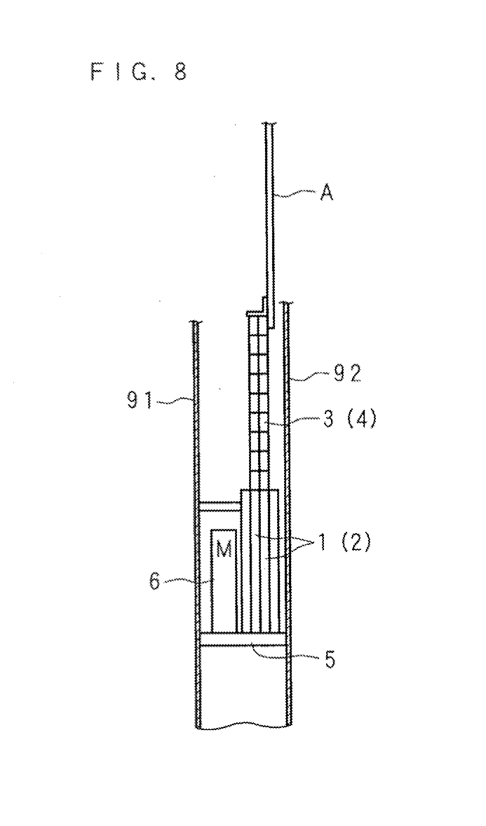

FIG. 8 is a schematic explanatory view illustrating a state in which the opening/closing unit is mounted to a vehicle door. The opening/closing unit configured as described above is disposed in the space between an inner panel 91 and an outer panel 92 of the vehicle door at, a position under the sliding body A as a window glass. Moreover, provided outside the inner panel 91 is an operation section 10 for starting a forward/reverse rotation of the electric motor 6, that is, the operation section 10 for sliding the sliding body A in an opening direction and a closing direction.

The supporting body 5 in the opening/closing unit is fastened between the inner panel 91 and the outer panel 92, the rotary gears 1 and 2 and the storage sections 8, 8 are disposed apart from each other in a direction along the lower edge of the sliding body A, and the guide body 7 is positioned under the rotary gears 1 and 2. On one end side of the chains 3 and 4 placed facing each other between the rotary gears 1 and 2, the chain sections 3a and 4a engage with the sprockets 1a and 2a of the rotary gears 1 and 2, and the flexure preventing sections 35, 35 . . . , 45, 45 . . . come into engagement with each other to form a non-flexible portion in the form of an angular bar which is prevented from flexing. One ends of the chains 3 and 4 are fastened in the non-flexible state to the center of the lower edge of the sliding body A. The other ends of the chains 3 and 4 are stored in the storage sections 8, 8 by guiding the chain sections 3a and 4a with the guide parts 81, 81.

In a state in which the vehicle window is opened by sliding the sliding body A in the opening direction like the sliding body A illustrated by the alternate long and two short dashes line in FIG. 1, when the operation section 10 is operated for closing, the rotary gears 1 and 2 are rotated in the directions indicated with the solid-line arrows in FIG. 1 by the electric motor 6, and the flexure preventing sections 35, 35 . . . , 45, 45 . . . come into engagement with each other while guiding the other ends of the chains 3 and 4 to the space between the rotary gears 1 and 2 by the first guide sections 71, 71 and the second guide sections 72, 72. Thus, the chains 3 and 4 are prevented from flexing in separating directions and joined together, and the one end side of the chains 3 and 4 becomes a non-flexible portion in the form of an angular bar and slides the sliding body A in the closing direction to close the vehicle window.

In a state in which the vehicle window is closed by sliding the sliding body A in the closing direction like the sliding body A illustrated by the solid line in FIG. 1, when the operation section 10 is operated for opening, the rotary gears 1 and 2 are rotated in the directions indicated with the broken-line arrows in FIG. 1 by the electric motor 6, and the flexure preventing sections 35, 35 . . . , 45, 45 . . . come out of engagement while guiding the other end side of the chains 3 and 4 in separating directions by the first guide sections 71, 71 and the second guide sections 72, 72. Consequently, the chains 3 and 4 become flexible, and the other end side of each of the chains 3 and 4 is stored in the storage sections 8, 8 to slide the sliding body. A in the opening direction and open the vehicle window.

### Embodiment 2

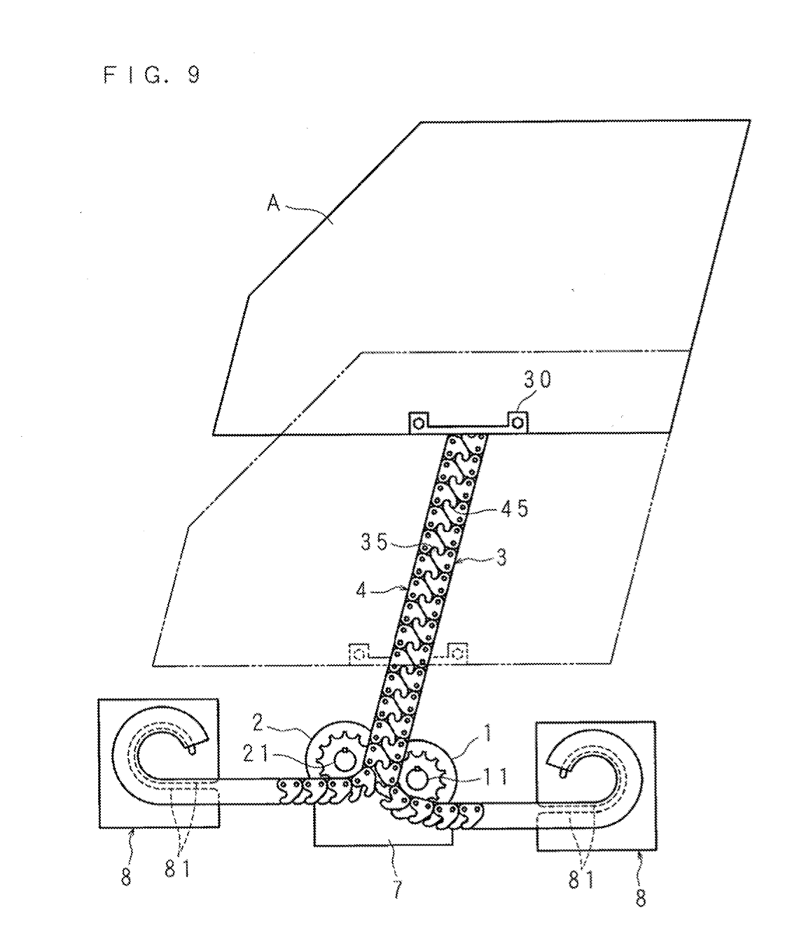

FIG. 9 is a schematic front view illustrating other structure of the opening/closing unit. The opening/closing unit in Embodiment 2 is designed to move one end side of the chains 3 and 4, which are placed to face each other between the rotary gears 1 and 2, in a direction slightly slanting from a vertical position by slightly displacing in a vertical direction the rotary gears 1 and 2 which are disposed apart from each other in a lateral direction.

In this embodiment, the window glass (sliding body A), which is mounted, for example, in a vehicle window slidably in a direction slanting from the vertical direction, may be slid in the opening direction and closing direction in the same manner as in Embodiment 1.

Since other structures and functions are the same as in Embodiment 1, similar parts are designated with the same reference codes, and the detailed explanation thereof and an explanation of the functions will be omitted.

### Embodiment 3

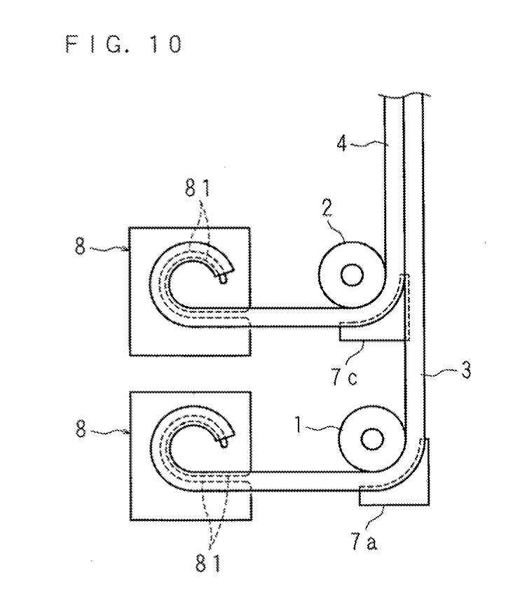

FIG. 10 is a schematic explanatory view illustrating other structure of the opening/closing unit. In the opening/closing unit of this embodiment, the rotary gears 1 and 2 are disposed apart from each other in the longitudinal direction of the non-flexible portion of one end side of the chains 3 and 4 which is prevented from flexing by the flexure preventing sections 35, 35, . . . 45, 45 . . . , that is, in the direction in which the sliding body A slides. Moreover, one of substantially L-shaped two guide bodies 7a and 7c, namely the guide body 7a is disposed in the vicinity of the rotary gear 1 and the other guide body 7c is disposed in the vicinity of the rotary gear 2 to guide the chains 3 and 4 in the same direction that crosses the longitudinal direction of the non-flexible portion. The storage sections 8, 8 are disposed apart from each other in the longitudinal direction of the non-flexible portion.

In this embodiment, in a state in which the vehicle window is opened by sliding the sliding body A in the opening direction, when the operation section 10 is operated for closing, the rotary gears 1 and 2 are rotated in the counterclockwise direction in FIG. 10 by the electric motor 6, and the flexure preventing sections 35, 35 . . . , 45, 45 . . . come into engagement with each other while guiding the other end side of the chains 3 and 4 toward the rotary gears 1 and 2 by the guide bodies 7a and 7c. Thus, the chains 3 and 4 are prevented from flexing in separating directions and joined together, and the one end side of the chains 3 and 4 becomes the non-flexible portion in the form of an angular bar to slide the sliding body A in the closing direction and close the vehicle window.

In a state in which the vehicle window is closed by sliding the sliding body A in the closing direction, when the operation section 10 is operated for opening, the rotary gears 1 and 2 are rotated in the clockwise direction in FIG. 10 by the electric motor 6, and the flexure preventing sections 35, 35 . . . , 45, 45 . . . come out of engagement while guiding the other end side of the chains 3 and 4 in the same direction by the guide bodies 7a and 7c. Consequently, the chains 3 and 4 become flexible, and the other end side of each of the chains 3 and 4 is stored in the storage sections 8, 8 to slide the sliding body A in the opening direction and open the vehicle window.

Since other structures and functions are the same as in Embodiment 1, similar parts are designated with the same reference codes, and the detailed explanation thereof and an explanation of the functions will be omitted.

### Embodiment 4

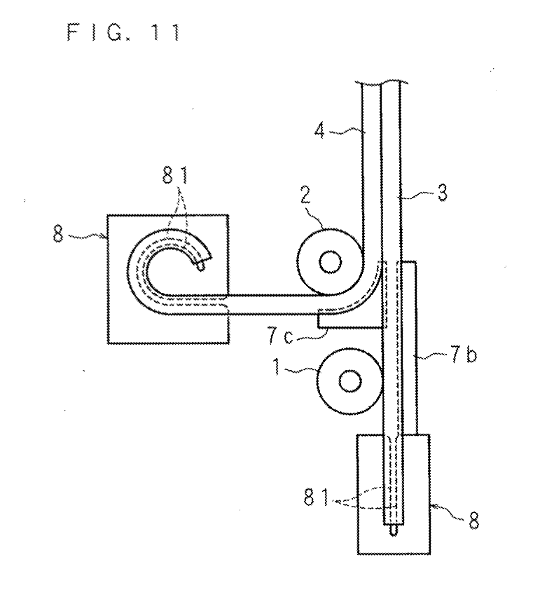

FIG. 11 is a schematic explanatory view illustrating other structure of the opening/closing unit. In the opening/closing unit of this embodiment, the rotary gears 1 and 2 are disposed apart from each other in the longitudinal direction of a non-flexible portion of one end side of the chains 3 and 4 which is prevented from flexing by the flexure preventing sections 35, 35, . . . 45, 45 that is, in the direction in which the sliding body A slides. Moreover, a substantially I-shaped guide body 7b for guiding the chain 3 in the longitudinal direction of the non-flexible portion is disposed in the vicinity of the rotary gear 1, a substantially L-shaped guide body 7c for guiding the chain 4 in a direction crossing the longitudinal direction of the non-flexible portion is disposed in the vicinity of the rotary gear 2, one storage section 8 is provided on a side in the longitudinal direction, and the other storage section 8 is arranged on a side in the direction crossing the longitudinal direction.

In this embodiment, in a state in which the vehicle window is opened by sliding the sliding body A in the opening direction, when the operation section 10 is operated for closing, the rotary gears 1 and 2 are rotated in the counterclockwise direction in FIG. 11 by the electric motor 6, and the flexure preventing sections 35, 35 . . . , 45, 45 . . . come into engagement with each other while guiding the other end side of the chains 3 and 4 toward the rotary gears 1 and 2 by the guide bodies 7b and 7c. Thus, the chains 3 and 4 are prevented from flexing in separating directions and joined together, and the one end side of the chains 3 and 4 becomes the non-flexible portion in the form of an angular bar to slide the sliding body A in the closing direction and close the vehicle window.

In a state in which the vehicle window is closed by sliding the sliding body A in the closing direction, when the operation section 10 is operated for opening, the rotary gears 1 and 2 are rotated in the clockwise direction in FIG. 11 by the electric motor 6, and the flexure preventing sections 35, 35 . . . , 45, 45 . . . come out of engagement while guiding the other end side of the chain 3 in the longitudinal direction of the non-flexible portion by the guide body 7b and guiding the other end side of the chain 4 in a direction crossing the longitudinal direction of the non-flexible portion by the guide body 7c. Consequently, the chains 3 and 4 become flexible, and the other end side of each of the chains 3 and 4 is stored in the storage sections 8, 8 to slide the sliding body A in the opening direction and open the vehicle window.

Since other structures and functions are the same as in Embodiment 1, similar parts are designated with the same reference codes, and the detailed explanation thereof and an explanation of the functions will be omitted.

### Embodiment 5

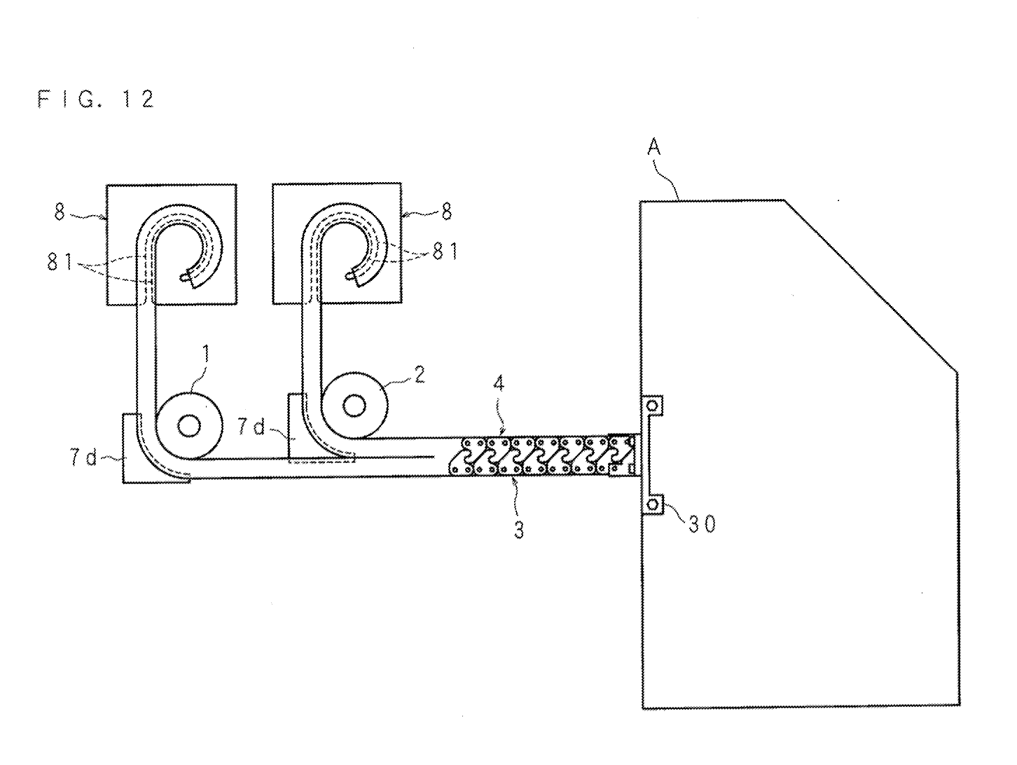

FIG. 12 is a schematic explanatory view illustrating other structure of the opening/closing unit. The opening/closing unit in this embodiment slides a sliding body A which is mounted slidably in the entrance/exit of a building, instead of sliding a sliding body A which is mounted slidably in a vehicle window. The opening/closing unit of Embodiment 5 is constructed by disposing the rotary gears 1 and 2 with a space therebetween in a sliding direction of the sliding body A, placing one of two substantially L-shaped guide bodies 7d and 7d in the vicinity of the lower side of the rotary gear 1, and positioning the other guide body 7d in the vicinity of the lower side of the rotary gear 2 to guide the other end side of each of the chains 3 and 4 in a vertical direction. Moreover, the storage sections 8, 8 are disposed above the rotary gears 1 and 2. Furthermore, a driving circuit of the electric motor 6 is connected to a sensor provided in the vicinity of the entrance/exit, and the opening/closing unit is driven on the basis of an output signal of the sensor. Note that the sensor forms the operation section.

In this embodiment, when closing the opened entrance/exit, the rotary gears 1 and 2 are rotated in the counterclockwise direction in FIG. 12 by the electric motor 6, and the flexure preventing sections 35, 35 . . . , 45, 45 . . . come into engagement with each other while guiding the other end side of the chains 3 and 4 from the upper side into a lateral direction by the guide bodies 7d and 7d. Thus, the chains 3 and 4 are prevented from flexing in separating directions and joined together, and the one end side of the chains 3 and 4 become a non-flexible portion in the form of an angular bar to slide the sliding body A in the closing direction and close the entrance/exit.

When opening the closed entrance/exit, the rotary gears 1 and 2 are rotated in the clockwise direction in FIG. 12 by the electric motor 6, and the flexure preventing sections 35, 35 . . . , 45, 45 . . . come out of engagement while guiding the other end side of the chains 3 and 4 from a lateral direction into an upward direction by the guide bodies 7d and 7d. Consequently, the chains 3 and 4 become flexible, and the other end side of each of the chains 3 and 4 is stored in the storage sections 8, 8 to slide the sliding body A in the opening direction and open the entrance/exit.

### Embodiment 6

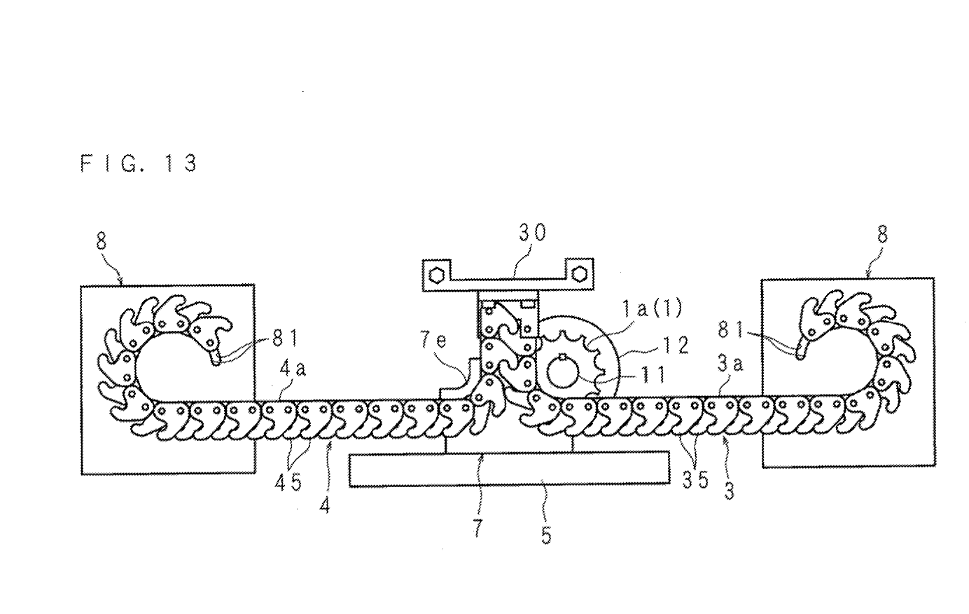

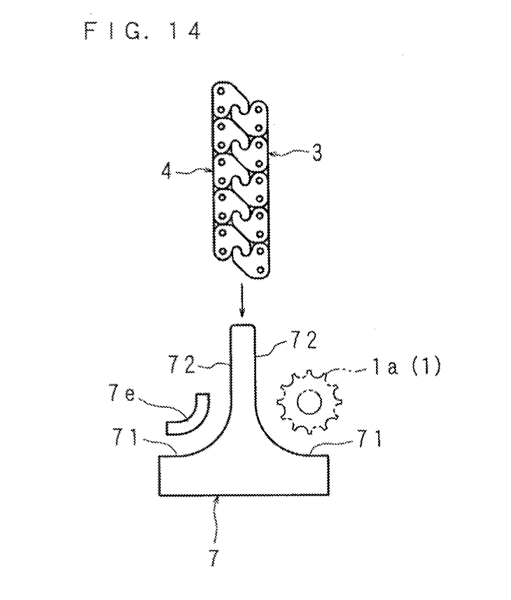

FIG. 13 is a schematic front view illustrating other structure of the opening/closing unit, and FIG. 14 is an explanatory view illustrating the relation between the rotary gear and the guide body. The opening/closing unit of this embodiment is constructed by removing the rotary gear 2 and including a guide body 7e in place of the rotary gear 2 so that one chain 3 engages with the rotary gear 1 driven by the electric motor 6 and the other chain 4 which is joined with the chain 3 by the engagement of the flexure preventing sections 35, 35, . . . , 45, 45 . . . moves in an interlocking manner with the chain 3.

The guide body 7e is in the form of a plate and comes into contact with the circumferential face of each roller 34, 44 of the chain 3, 4. As illustrated in FIG. 14, the guide body 7e has a substantially L-shaped guide section located at a position facing one of the first guide sections 71 and one of the second guide sections 72 of the guide body 7 with a space therebetween. The shape of the guide body 7e is not particularly limited and may have a circular plate shape instead of the substantially L shape. The guide body 7e may be a circular plate which is fixed, or rotatably supported. The guide body 7e may be integrated with the guide body 7 as one unit.

In this embodiment, the chain section 3a of the chain 3, that is one of the chains 3 and 4 placed to face each other between the rotary gear 1 and the guide body 7e, engages with the rotary gear 1, and one end side of the chains 3 and 4 becomes a non-flexible portion in the form of an angular bar which is prevented from flexing by the engagement of the flexing sections 35, 35, . . . 45 and 45.

When the rotary gear 1 is rotated in the clockwise direction, or the counterclockwise direction, in FIG. 13 by the electric motor 6 and the one chain 3 moves, the movement of the chain 3 is transmitted to the other chain 4 from the flexure preventing sections 35, 35, . . . 45, 45 . . . , and the chain 4 moves in an interlocking manner.

Thus, since the two chains 3 and 4 are moved by a single rotary gear 1, the number of parts is reduced, the costs are reduced, and also the size and weight are reduced, which enables the opening closing unit to be placed in a relatively narrow space.

Since other structures and functions are the same as in Embodiments 1 to 5, similar parts are designated with the same reference codes, and the detailed explanation thereof and an explanation of the functions will be omitted.

### Embodiment 7

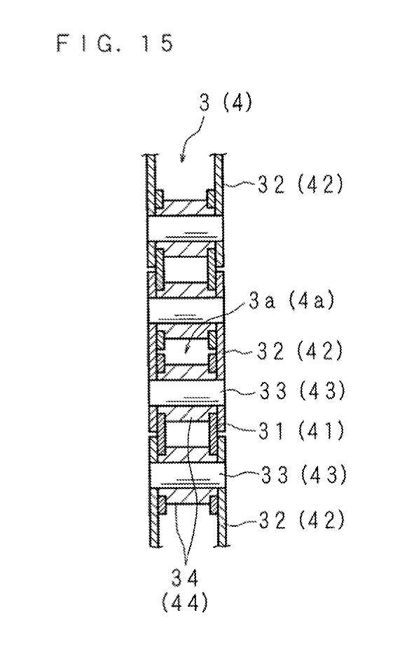

FIG. 15 is an enlarged cross sectional view of the chain in the other structure of the opening/closing unit. The opening/closing unit of this embodiment is constructed by arranging one-strand roller chains 3 and 4 to face each other instead of placing two-strand roller chains 3 and 4 to face each other.

The chains 3 and 4 of this embodiment may also be applied to the opening/closing units of Embodiments 1 to 6. In this case, each of the rotary gears 1 and 2 has one sprocket 1a or 2a. Even in this structure, the chains 3 and 4 have the flexure preventing sections 35 and 45 which prevent flexing of the chains 3 and 4 and join them together in the form of an angular bar, and are therefore able to slide the sliding body A.

Since other structures and functions are the same as in Embodiments 1 to 6, similar parts are designated with the same reference codes, and the detailed explanation thereof and an explanation of the functions will be omitted.

### Embodiment 8

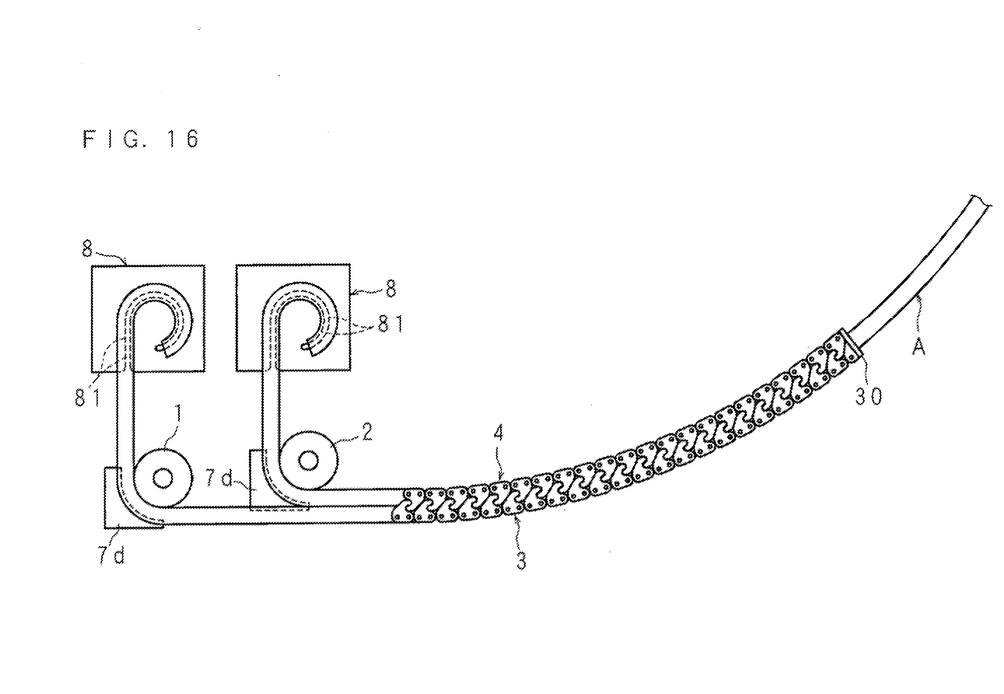

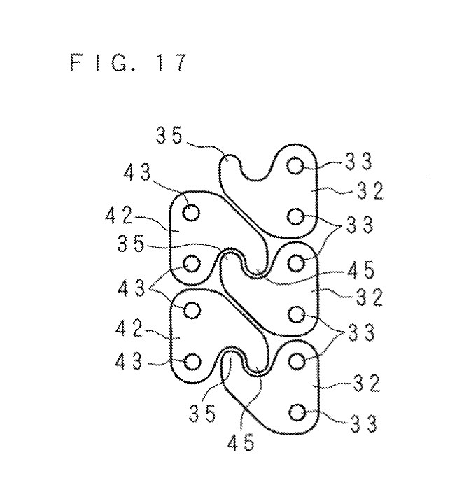

FIG. 16 is a schematic plan view illustrating other structure of the opening/closing unit, and FIG. 17 is a partly enlarged front view of the chain. The opening/closing unit of this embodiment enables the non-flexible portions, which are prevented from flexing by the flexure preventing sections 35 and 45 and joined together in the form of an angular bar, to curve in a flexing direction of the chains 3 and 4.

In the opening/closing unit of Embodiment 8, a slight space is provided as illustrated in FIG. 17 between the peripheral faces of the flexure preventing sections 35 and 45 of the chains 3 and 4 which come into engagement with each other. Thus, in the opening/closing unit of Embodiment 8, the chains 3 and 4 are allowed to curve to one side or the other in the flexing direction of the chains 3 and 4 by an amount corresponding to the space, and the peripheral faces of the flexure preventing sections 35 and 45 come into engagement with each other in a slightly curved state to prevent further curving.

In the opening/closing unit of Embodiment 8, the rotary gears 1 and 2 are disposed apart from each other in the sliding direction of the sliding body A. In the opening/closing unit, one of two substantially L-shaped guide bodies 7d and 7d is placed in the vicinity of the lower side of the rotary gear 1 and the other guide body 7d is positioned in the vicinity of the lower side of the rotary gear 2 to guide the other end side of the chains 3 and 4 in an upward direction. The storage sections 8, 8 are disposed above the rotary gears 1 and 2.

In this embodiment, when a sliding body A to be mounted slidably in a vehicle window is curved and slidable in a direction along the curve of the sliding body A, or when a sliding body A such as a door to be mounted slidably in the entrance/exit of a building is curved and slidable in a direction along the curve of the sliding body A, the curved sliding body A may be slid in a direction along the curve of the sliding body A.

Since other structures and functions are the same as in Embodiments 1 to 7, similar parts are designated with the same reference codes, and the detailed explanation thereof and an explanation of the functions will be omitted.

### Embodiment 9

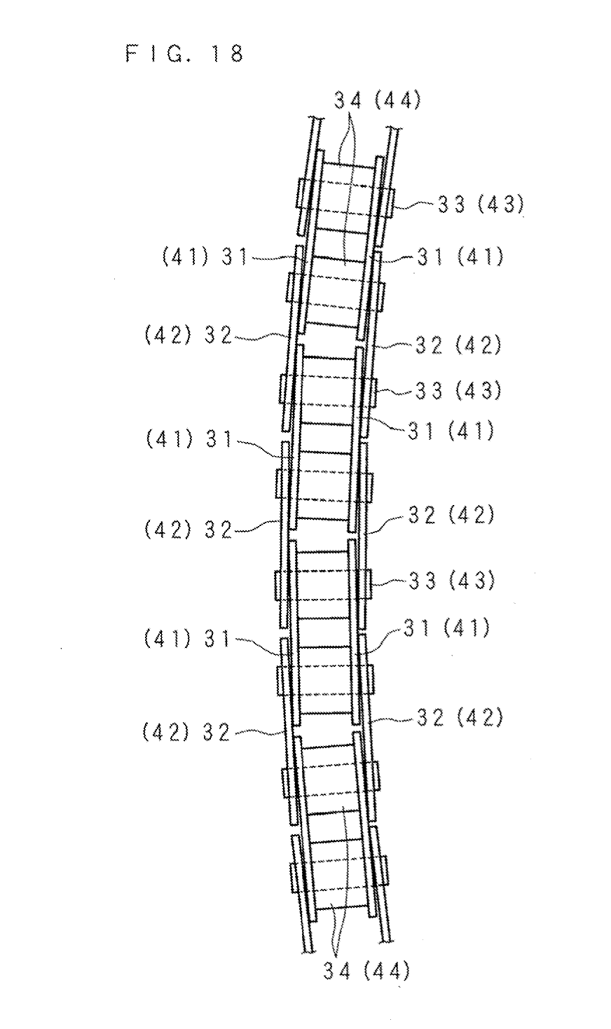

FIG. 18 is an enlarged side view of the chain in the other structure of the opening/closing unit. The opening/closing unit of this embodiment enables the chains 3 and 4 to curve in a direction orthogonal to the flexing direction of the chains 3 and 4, that is, in a direction orthogonal to the surfaces of the roller link plates 31, 31 . . . , 41, 41 . . . and pin link plates 32, 32 . . . 42, 42 . . . . Although FIG. 18 illustrates one-strand roller chain 3 or 4, other chains such as double-strand roller chains may also be used. Since the chains 3 and 4 have the same configuration, the following will explain only the chain 3.

The chain 3 of Embodiment 9 has a slight space between the opposing surfaces of each of the roller link plates 31, 31 . . . and the pin link plates 32, 32 . . . , and between the fitting hole 32a of each of the pin link plates 32, 32 . . . and the pin 33, and the roller link plates 31, 31 . . . and the pin link plates 32, 32 . . . are allowed to be displaced relatively by an amount corresponding to the space in a direction orthogonal to the flexing direction. The chains 3 and 4 are configured to curve as illustrated in FIG. 18 with the relative displacement of the roller link plates 31, 31 . . . and the pin link plates 32, 32 . . . .

The roller link plates 31, 31 . . . and the pin link plates 32, 32 . . . are provided with the flexure preventing sections 35, 35 . . . , 45, 45 . . . , and the chains 3 and 4 are configured to curve in a state in which the flexure preventing sections 35, 35 . . . , 45, 45 . . . are in engagement with each other and prevent flexing of the chains 3 and 4.

In this embodiment, when a sliding body A to be mounted slidably in a vehicle window is curved and slidable in a direction along the curve of the sliding body A, or when a sliding body A such as a door to be mounted slidably in the entrance/exit of a building is curved and slidable in a direction along the curve of the sliding body A, the curved sliding body A may be slid in a direction along the curve of the sliding body A.

Since other structures and functions are the same as in Embodiments 1 to 7, similar parts are designated with the same reference codes, and the detailed explanation thereof and an explanation of the functions will be omitted.

In the above-explained embodiments, the respective roller link plates 31 and 41 and pin link plates 32 and 42 of the two chains 3 and 4 have the flexure preventing sections 35 and 45, but it may also be possible to configure one of the respective roller link plates 31, 41 and the respective pin link plates 32, 42 to have the flexure preventing sections 35 and 45.

The above-described embodiments illustrate structures including the guide bodies 7, 7a-7d for guiding two chains 3 and 4, but it may be possible to configure a structure without a guide body. In this case, for example, the other end side (flexible portion) of the chains 3 and 4 is arranged to drop by its own weight.

An opening/closing unit according to the present invention may be configured by disposing the opening/closing unit on both sides in a sliding direction of two sliding bodies A which are mounted to be slidable in approaching and separating directions, attaching one ends of the chains 3 and 4 in the opening/closing unit located on one side to one of the sliding bodies A and attaching one ends of the chains 3 and 4 in the opening/closing unit located on the other side to the other sliding body A, and synchronizing the two sliding bodies A which are slidable in the approaching and separating directions for opening/closing.

Moreover, an opening/closing unit according to the present invention may be configured by disposing two opening/closing units on one side in a sliding direction of two sliding bodies A which are mounted to be slidable in approaching and separating directions, attaching one ends of the chains 3 and 4 in one of the opening/closing units to one of the sliding bodies A and attaching one ends of the chains 3 and 4 in the other opening/closing unit to the other sliding body A, and synchronizing the two sliding bodies A which are slidable in the approaching and separating directions by a single electric motor 6 for opening/closing.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An opening/closing unit for opening/closing an open section with a sliding body which is mounted slidably in the open section, comprising:
two chains placed to face each other and including flexible chain sections and flexure preventing sections which project from the chain sections and prevent flexing of the chain sections by coming into engagement with each other, each of the chains having one end attached to the sliding body; and
a rotary gear which engages with at least one of the chains from a side different from a side facing the other chain,
wherein the flexure preventing sections come into engagement with each other at a point located on the one end side with respect to an engaged portion where the chain engages with the rotary gear.

2. The opening/closing unit according to claim 1, comprising:
a guide body for coming into contact with the chain section at a point located on the other end side with respect to the engaged portion and guiding at least one of the two chains in a direction in which the chain section is flexed.

3. The opening/closing unit according to claim 1, comprising:
storage sections for storing the other end side of each of the chains with respect to the engaged portion.

4. The opening/closing unit according to claim 2, comprising:
storage sections for storing the other end side of each of the chains with respect to the engaged portion.

5. The opening/closing unit according to claim 3, wherein
the storage section includes two guide sections for guiding the chain section, the guide sections being placed facing each other with a space therebetween in a direction in which the chain section is flexible.

6. The opening/closing unit according to claim 1, wherein
each of the chains includes a section for allowing the chain to curve on the one end side where flexing is prevented by the flexure preventing sections.

7. The opening/closing unit according to claim 2, wherein
each of the chains includes a section for allowing the chain to curve on the one end side where flexing is prevented by the flexure preventing sections.

8. The opening/closing unit according to claim 3, wherein
each of the chains includes a section for allowing the chain to curve on the one end side where flexing is prevented by the flexure preventing sections.

9. The opening/closing unit according to claim 4, wherein
a plurality of the rotary gears are disposed apart from each other in a radial direction,
the chains are placed to face each other between the rotary gears,
the guide body includes two guide sections for guiding the chains respectively to the sides where the rotary gears are disposed, and
the storage sections are disposed on the sides where the rotary gears are disposed.

10. The opening/closing unit according to claim 4, wherein
a plurality of the rotary gears are disposed apart from each other in a longitudinal direction of a non-flexible portion where flexing is prevented by the flexure preventing sections,
the guide body includes two guide sections for guiding the chains to the same side in a direction crossing the longitudinal direction, and
the storage sections are disposed apart from each other in the longitudinal direction.

11. The opening/closing unit according to claim 4, wherein
a plurality of the rotary gears are disposed apart from each other in a longitudinal direction of a non-flexible portion where flexing is prevented by the flexure preventing sections,
the guide body includes a guide section for guiding one of the two chains to a side in a direction crossing the longitudinal direction, and a guide section for guiding the other of the two chains in the longitudinal direction, and
the storage sections are disposed on the side in the direction crossing the longitudinal direction and on a side in the longitudinal direction.

12. An opening/closing unit for vehicle windows for opening/closing a vehicle window with a window glass which is mounted slidably in the vehicle window, comprising:
two chains placed to face each other and including flexible chain sections and flexure preventing sections which project from the chain sections and prevent flexing of the chain sections by coming into engagement with each other, each of the chains having one end attached to the window glass; and
a rotary gear which engages with at least one of the chains from a side different from a side facing the other chain,
wherein the flexure preventing sections come into engagement with each other at a point located on the one end side with respect to an engaged portion where the chain engages with the rotary gear.

13. An opening/closing unit for vehicle windows for opening/closing a vehicle window with a window glass which is mounted vertically slidably in the vehicle window, comprising:
two chains placed to face each other and including flexible chain sections and flexure preventing sections which project from the chain sections and prevent flexing of the chain sections by coming into engagement with each other, each of the chains having one end attached to a lower edge of the window glass;
a rotary gear which engages with at least one of the chains from a side different from a side facing the other chain;
a guide body for coming into contact with the chain sections at a point located on the other end side with respect to an engaged portion where the chain engages with the rotary gear and guiding each of the chains in a lateral direction; and
storage sections for storing the other end side of each of the chains,
wherein the flexure preventing sections come into engagement with each other at a point located on the one end side with respect to the engaged portion.
